(19) United States
(12) Patent Application Publication
(10) Pub. No.: US 2004/0121284 A1
(43) Pub. Date: Jun. 24, 2004

(54) Head brush for a dental fissure cleaning device

(75) Inventor: Walter Hsu, Yinlin Hsien (TW)

Correspondence Address: BACON & THOMAS, PLLC, 625 SLATERS LANE, FOURTH FLOOR, ALEXANDRIA, VA, 22314

(73) Assignee: WELTER'S CO., LTD., Yinlin Hsien (TW)

(21) Appl. No.: 10/322,536

(22) Filed: Dec. 19, 2002

(51) Int. Cl. A61C 15/00

(52) U.S. Cl. 433/141; 132/321

(57) ABSTRACT

A head brush for a dental fissure cleaning device is mainly made up of a cleaning rod integrally injected into shape of safely edible plastic material and having a holding section disposed at the front end thereof, and a head brush of relatively slender stick adapted at the front of said holding section thereof wherein said head brush is equipped with a foremost rounded tip, and a plurality of long and short bristles planted in an alternating manner with a sectional view showing a triangular configuration. Via the foremost rounded tip, the cleaning rod can be safely guided into the dental fissures for cleansing thereof without harming the teeth gums. And with the long and short bristles moving back and forth at the dental fissure thereof, the head brush can easily pick out the remains of food attached at the dental fissures and cleansed up the scale or tartar on the teeth so as to effectively prevent dental cavity or other dental diseases.

### BACKGROUND OF THE INVENTION

The present invention is related to a head brush for a dental fissure cleaning device, mainly made up of a cleaning rod integrally injected into shape of safely edible plastic material and having a holding section disposed at the front end thereof, and a head brush of relatively slender stick adapted at the front of said holding section thereof. Said head brush having a foremost rounded tip, and a plurality of long and short bristles planted in an alternating manner thereon can be safely guided into the dental fissures for cleansing thereof without harming the teeth gums. With said long and short bristles moving back and forth at the dental fissure thereof, said head brush can easily pick out the remains of food attached at the dental fissures and cleansed up the scale or tartar on the teeth, preventing dental cavity or other dental diseases.

Please refer to FIG. 1. A conventional head brush for a dental fissure cleaning device is quipped with a cleaning rod 10 having a tapered holding section 11 disposed at the front thereof, and a head brush 12 adapted to the front end of said tapered holding section 11 thereof. Said head brush 12 is made up of two intertwined slim stainless wires with a plurality of nylon bristles 13 interlaced and planted thereto. In practical use, the nylon bristles 13 of said head brush 12 are applied onto the teeth for cleansing thereof. When said nylon bristles 13 are extended to cleanse the dental fissures, teeth gums are easily harmed into bleeding by the intertwined stainless wires of said head brush 12 thereof. Besides, said head brush 12 is easily broken after repeated usage.

Please refer to FIG. 2. To cleanse the molar teeth, said nylon bristles 13 thereof are extended into the rear side of the oral cavity. Said head brush 12 is bent into an angle to cleanse the dental fissures thereof, which makes the teeth gums easily hurt by a tip A of said head brush 12. Besides, due to the inflexibility of the stainless wires, said head brush 12 can be easily broken when overstretched in use.

### SUMMARY OF THE PRESENT INVENTION

It is, therefore, the primary purpose of the present invention to provide a head brush for a dental fissure cleaning device, comprising an integrally molded brush rod, a brush head adapted to the front of said brush rod thereof, and a plurality of long and short bristles planted in an alternating manner at said brush head thereon wherein said long and short bristles moving back and forth at the dental fissure thereof can easily pick out the remains of food attached at the dental fissures and cleanse up the scale or tartar on the teeth, preventing dental cavity or other dental diseases.

It is, therefore, the secondary purpose of the present invention to provide a head brush for a dental fissure cleaning device wherein said head brush having a foremost rounded tip disposed at the front thereof can be safely guided into the dental fissures for cleansing without harming the teeth gums thereof.

It is, therefore, the third purpose of the present invention to provide a head brush for a dental fissure cleaning device wherein said brush rod is integrally injected into shape with safe plastic material of edible standard, economically cutting down the time as well as the cost of production.

### BRIEF DESCRIPTION OF THE DRAWINGS

FIG. 1 is a diagram showing a conventional head brush for a dental fissure cleaning device in operation.

FIG. 2 is another diagram showing said conventional head brush thereof in operation.

FIG. 3 is a perspective view of the present invention.

FIG. 4 is a partially sectional view of the present invention.

FIG. 5 is a diagram showing the present invention in operation.

FIG. 6 is another diagram showing the present invention in operation in another direction.

FIG. 7 is a third diagram showing the present invention in operation.

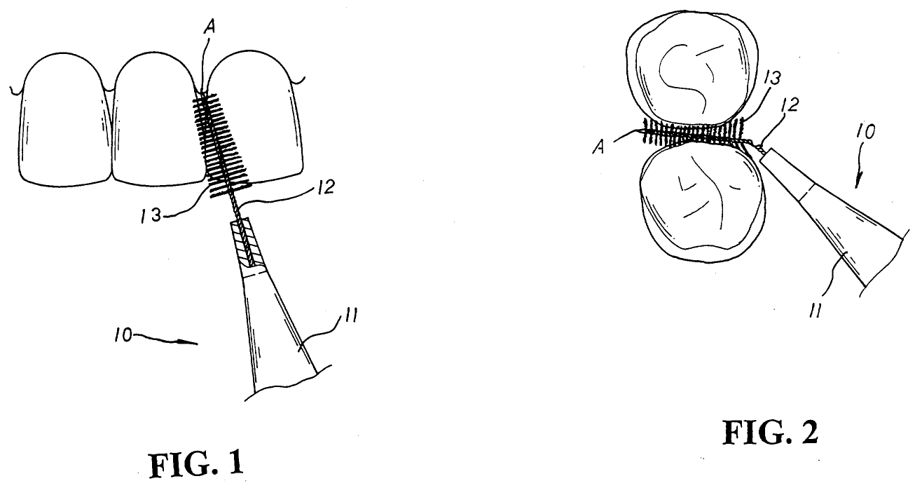

### DETAILED DESCRIPTION OF THE PREFERRED EMBODIMENTS

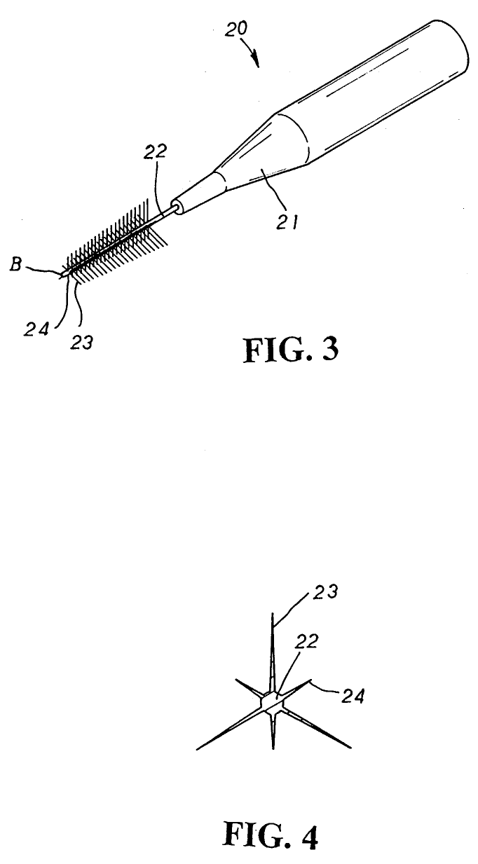

Please refer to FIG. 3. The present invention is related to a head brush for a dental fissure cleaning device, mainly made up of a cleaning rod 20 integrally injected into shape of safely edible plastic material, a holding section 21 disposed at the front end of said cleaning rod 20 thereof, and a head brush 22 of relatively slender stick extending at the front of said holding section 21 thereof.

Said head brush 22 is equipped with a foremost rounded tip B, and a plurality of long and short bristles 23, 24 properly planted in an alternating manner for a certain length thereon. The sectional view of said planted long and short bristles 23, 24 displays a triangular configuration as shown in FIG. 4.

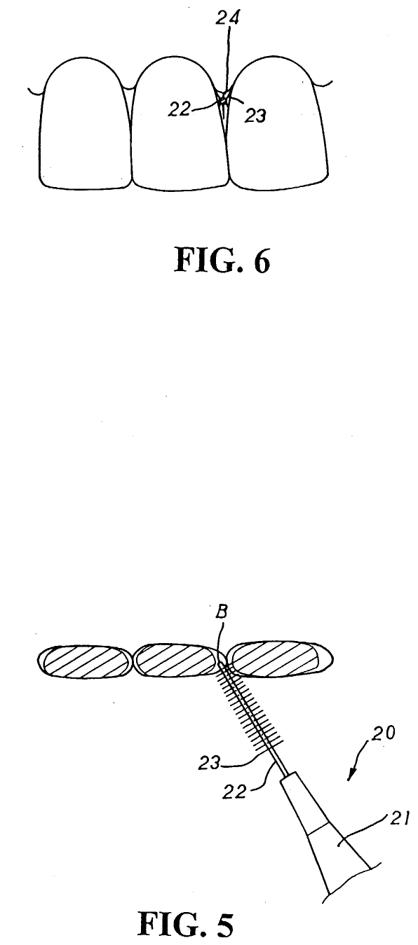

Please refer to FIGS. 5, 6. In practical use, a user can hold said cleaning rod 20 via said holding section 21 and easily cleanse up the dental fissures via said head brush 22. Via the foremost rounded tip B, the long and short bristles 23, 24 of said head brush 22 thereof can be safely guided into the dental fissures for cleansing thereof without harming the teeth gums as shown in FIG. 5. Moreover, said long and short bristles 23, 24, with the sectionally triangular configuration to fit into the dental fissure thereof, are abutted against the facets of teeth so that said head brush 22 can easily pick out remains of food attached at the dental fissure thereof as shown in FIG. 6. With said long and short bristles 23, 24 moving back and forth at the dental fissure thereof, said head brush 22 can also easily and quickly cleanse the scale or tartar on the teeth, effectively preventing dental cavity or other dental diseases.

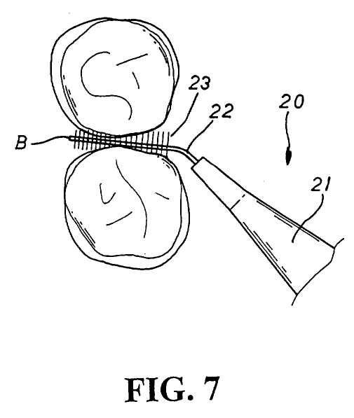

Please refer to FIG. 7. To clean up the molar teeth at the rear side of the oral cavity, a flexible head brush 22 can be adapted wherein said flexible head brush 22, bent into an angle, is guided to the molar teeth via said foremost rounded tip B to cleanse up the dental fissure thereof via said long and short bristles 23, 24 thereof.

What is claimed is:

1. A head brush for a dental fissure cleaning device, mainly made up of a cleaning rod having a holding section disposed at the front end thereof, and a head brush of relatively slender stick adapted at the front of said holding section thereof wherein said head brush is equipped with a foremost rounded tip, and a plurality of long and short bristles properly planted in an alternating manner for a certain length thereon;
whereby, via the foremost rounded tip thereof, said head brush thereof can be safely guided into the dental fissures for cleansing thereof without harming the teeth gums; with said long and short bristles thereof moving back and forth at the dental fissures, said head brush can easily pick out the remains of food attached at the dental fissures and cleanse the scale or tartar on the teeth, effectively preventing dental cavity or other dental diseases.

2. The head brush for a dental fissure cleaning device as claimed in claim 1 wherein said cleaning rod thereof is integrally injected into shape.

3. The head brush for a dental fissure cleaning device as claimed in claim 1 wherein the sectional view of said long and short bristles thereof displays a triangular configuration.

4. The head brush for a dental fissure cleaning device as claimed in claim 1 wherein said cleaning rod is integrally molded via safe plastic material of edible standard.
